(19) United States
(12) Patent Application Publication
(10) Pub. No.: US 2025/0181952 A1
(43) Pub. Date: Jun. 5, 2025

(54) FAULT-TOLERANT QUANTUM COMPUTING ARCHITECTURE

(71) Applicant: International Business Machines Corporation, Armonk, NY (US)

(72) Inventors: Sergey Bravyi, Ossining, NY (US); Andrew W. Cross, Yorktown Heights, NY (US); Jay Michael Gambetta, Yorktown Heights, NY (US); Dmitri Maslov, Great Falls, VA (US); Patrick Julian Tassilo Rall, Boston, MA (US); Kevin Tien, Trumbull, CT (US); Theodore James Yoder, Mohegan Lake, NY (US)

(21) Appl. No.: 18/527,304

(22) Filed: Dec. 3, 2023

(51) Int. Cl. G06N 10/40; G06N 10/20

(52) U.S. Cl. CPC G06N 10/40; G06N 10/20

(57) ABSTRACT

According to an embodiment, a structure for a qubit architecture is presented. The structure may include a plurality of qubits. The structure may include a plurality of couplings between each qubits. The couplings are arranged based on a relationship between each qubit and its placement on a torus. The coupling for each qubit comprises coupling to four nearest neighbor qubits on the torus and coupling to two cross-coupled qubits based on a definition and a set of parameters of a bivariate bicycle code. Methods for using and manufacturing the qubit architecture are additionally presented.

The following disclosure(s) are submitted under 35 U.S.C. 102(b)(1)(A):
DISCLOSURE(S): High-threshold and low-overhead fault-tolerant quantum memory, Sergey Bravyi, Andrew W. Cross, Jay M. Gambetta, Dmitri Maslov, Patrick Rall, and Theodore J. Yoder, 15 Aug. 2023, arXiv: 2308.07915v1.

Aspects of the disclosure may be contained in the claims along with additional material and should be examined accordingly.

### BACKGROUND

The present invention relates to quantum computing, and more specifically, to architectures implementing quantum error correcting codes.

Quantum error correction (QEC) is used in quantum computing to protect quantum information from errors due to decoherence and other quantum noise. Quantum error correction may be essential to achieving fault tolerant quantum computing that can reduce the effects of noise on stored quantum information, quantum gates, quantum preparation, and measurements.

Classical error correcting codes use a syndrome measurement to diagnose which error corrupts an encoded state. An error can then be reversed by applying a corrective operation based on the syndrome. Quantum error correction also employs syndrome measurements. It performs a multi-qubit measurement that does not disturb the quantum information in the encoded state but retrieves information about the error. Depending on the QEC code used, syndrome measurement can determine the occurrence, location and type of errors. In most QEC codes, the type of error is either a bit flip, or a sign (of the phase) flip, or both (corresponding to the Pauli matrices X, Z, and Y). The measurement of the syndrome has the projective effect of a quantum measurement, so even if the error due to the noise was arbitrary, it can be expressed as a combination of basis operations called the error basis (which is given by the Pauli matrices and the identity). To correct the error, the Pauli operator corresponding to the type of error is used on the corrupted qubits to revert the effect of the error.

The syndrome measurement provides information about the error that has happened, but not about the information that is stored in the logical qubit—as otherwise the measurement would destroy any quantum superposition of this logical qubit as well as any entanglement with other qubits in the quantum computer, which would prevent it from being used to perform quantum computation.

### SUMMARY

According to an embodiment, a structure for a qubit architecture is presented. The structure may include a plurality of qubits. The structure may include a plurality of couplings between each qubits. The couplings are arranged based on a relationship between each qubit and its placement on a torus. The coupling for each qubit comprises coupling to four nearest neighbor qubits on the torus and coupling to two cross-coupled qubits based on a definition and a set of parameters of a bivariate bicycle code.

According to a further embodiment of the above structure for a qubit architecture, a unit cell located on a grid of the torus comprises a first data qubit, an X-check qubit, a second data qubit, and a Z-check qubit, wherein the unit cells are arranged such that four nearest neighbor qubits of either the first data qubit or second data qubit are two X-check qubits and two Z-check qubits.

According to a further embodiment of the above structure for a qubit architecture, a Manhattan distance of the coupling for the two cross-coupled qubits is 9.

According to a further embodiment of the above structure for a qubit architecture, the parameters of the bivariate bicycle code are [144, 12, 12].

According to a further embodiment of the above structure for a qubit architecture, a routing for the two cross-couplings are based on a coupling table for the parameters of the bivariate bicycle code.

According to another embodiment, a method of performing an error check on a quantum architecture is presented for the structure of the qubit architecture is presented. The method may include initializing a plurality of X-check qubits and Z-check qubits coupled to a first data qubit and a second data qubit. The method may include performing a CNOT gate using each coupling of a first data qubit, and each coupling of a second data qubit. The method may include measuring each coupled X-check qubit used in each CNOT gate. The method may include measuring each coupled Z-check qubit used in each CNOT gate. The method may include determining an error based on switched state of any of the X-check qubits or Z-check qubits.

According to a further embodiment of the method of performing an error check on a quantum architecture, a unit cell located on a grid of the torus comprises a first data qubit, an X-check qubit, a second data qubit, and a Z-check qubit, wherein the unit cells are arranged such that four nearest neighbor qubits of either the first data qubit or second data qubit are two X-check qubits and two Z-check qubits.

According to a further embodiment of the method of performing an error check on a quantum architecture, a Manhattan distance of the coupling for the two additional qubits is 9.

According to a further embodiment of the method of performing an error check on a quantum architecture, a routing for the two cross-couplings are based on a coupling table for the parameters of the bivariate bicycle code.

According to a further embodiment of the method of performing an error check on a quantum architecture, wherein an ordering of the CNOTs is based on sets of non-overlapping connections between qubits, achieving parallel scheduling of CNOTs resulting in a circuit depth independent of torus dimensions.

According to another embodiment, a method of routing couplings of qubits is presented. The method may include receiving a qubit connectivity map on a non-planar surface comprising a plurality of qubits and a plurality of couplings between qubits. The method may include relating qubit position from the non-planar surface map to a planar surface. The method may include swapping positions of qubits on the planar surface while maintaining the couplings from the qubit connectivity map. The method may include determining a device layout by placing qubits according to locations on the planar surface and couplers between the qubits corresponding to the coupling map. The method may include changing a wiring level of a coupler in the device layout based on a physical overlap with another coupler.

According to a further embodiment of the method of routing couplings of qubits, a position of the qubit from the non-planar surface comprises flattening the non-planar surface to a planar surface.

According to a further embodiment of the method of routing couplings of qubits, flattening comprises overlapping a grid on a front surface of the non-planar surface with a grid from a back surface of the non-planar surface such that the grids coexist on a same surface of the planar surface.

According to a further embodiment of the method of routing couplings of qubits, flattening comprises placing a grid from a back surface of the non-planar surface a bottom surface of a planar substrate and a grid from a front surface of the non-planar qubit connectivity map on a top surface of the planar substrate.

According to a further embodiment of the method of routing couplings of qubits, the method may further include folding the planar surface along an axis.

According to a further embodiment of the method of routing couplings of qubits, where couplers on each wiring level only traverse a single direction.

According to a further embodiment of the method of routing couplings of qubits, where a first wiring level traverses an x-direction of the grid of the planar substrate.

According to a further embodiment of the method of routing couplings of qubits, where a second wiring level traverses a y-direction of the grid of the planar substrate.

According to a further embodiment of the method of routing couplings of qubits, where the method further includes causing fabrication of a device based on the device layout.

According to another embodiment, a folded qubit architecture is presented. The embodiment may include a qubit connectivity graph comprising a plurality of repeating unit cells of qubits and couplings. The embodiment may include a first unit cell located on a surface of a planar substrate. The embodiment may include a second unit cell located on the surface of the planar substrate, wherein qubits of the first unit cell are located between qubits of the second unit cell.

According to a further embodiment of the folded qubit architecture, the repeating unit cells comprise a first data qubit, an X-check qubit, a second data qubit, and a Z-check qubit, wherein the unit cells are arranged such that four nearest neighbor qubits of either the first data qubit or second data qubit are two X-check qubits and two Z-check qubits.

According to a further embodiment of the folded qubit architecture, couplings of the first unit cell and the second unit cell are based on a qubit connectivity map created a non-planar surface.

According to a further embodiment of the folded qubit architecture, the non-planar surface is a torus.

According to a further embodiment of the folded qubit architecture, wherein the unit cells are overlapping.

According to a further embodiment of the folded qubit architecture, coupling between an x-check qubit and L-data qubit is routed past a qubit of the second unit cell.

### BRIEF DESCRIPTION OF THE DRAWINGS

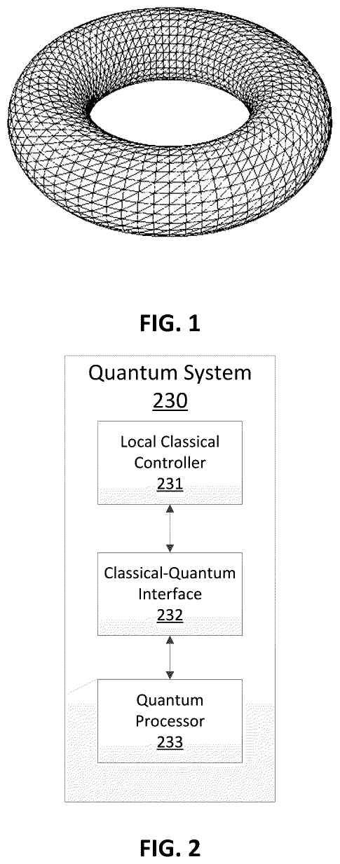

Referring to FIG. 1, an example torus is depicted;

Referring to FIG. 2, a quantum system is depicted, according to an example embodiment;

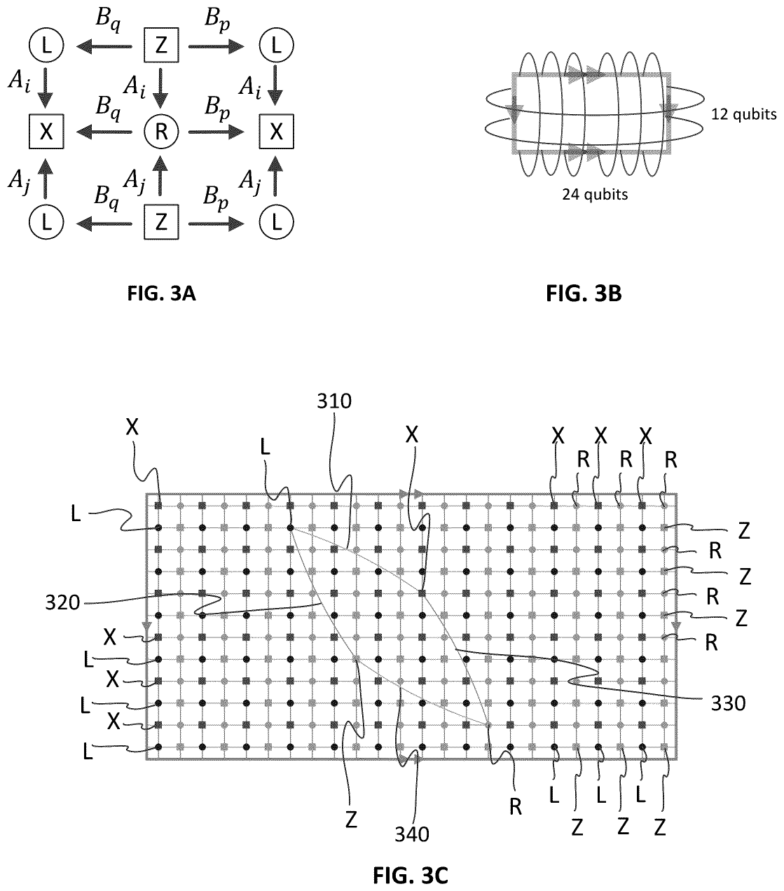

Referring to FIG. 3A, a unit cell of a Bivariave-Bicycle Code is depicted, according to an example embodiment;

Referring to FIG. 3B, connections of a planar grid to achieve similar connections to a torus are depicted, according to an example embodiment;

Referring to FIG. 3C, an architecture of a Bivariave-Bicycle Code on a torus is depicted, according to an example embodiment;

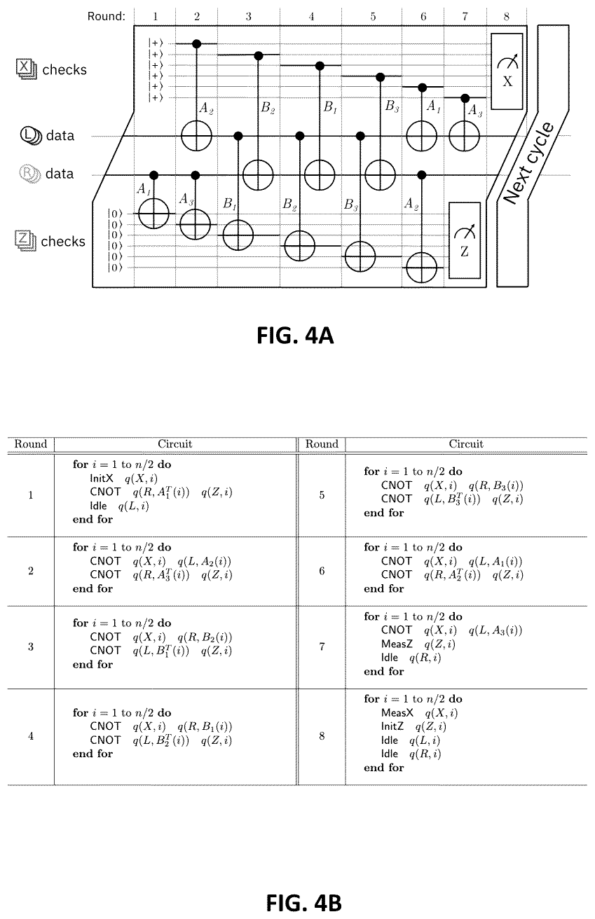

Referring to FIG. 4A, a quantum circuit for detecting an error based on the architecture of a Bivariave-Bicycle Code is depicted, according to an example embodiment;

Referring to FIG. 4B, a quantum circuit for detecting an error is depicted as pseudo-code, according to an example embodiment;

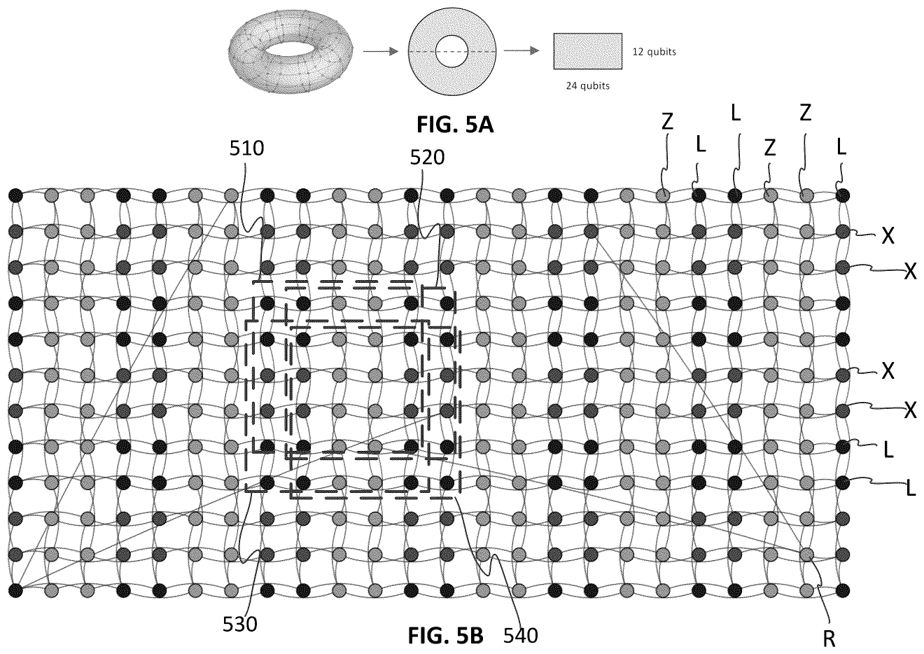

Referring to FIG. 5A, an example procedure for aligning a surface of a torus to a surface of a planar substrate is depicted, according to an example embodiment;

Referring to FIG. 5B, an architecture of the Bivariate-Bicycle Code on a planar substrate is depicted, according to an example embodiment;

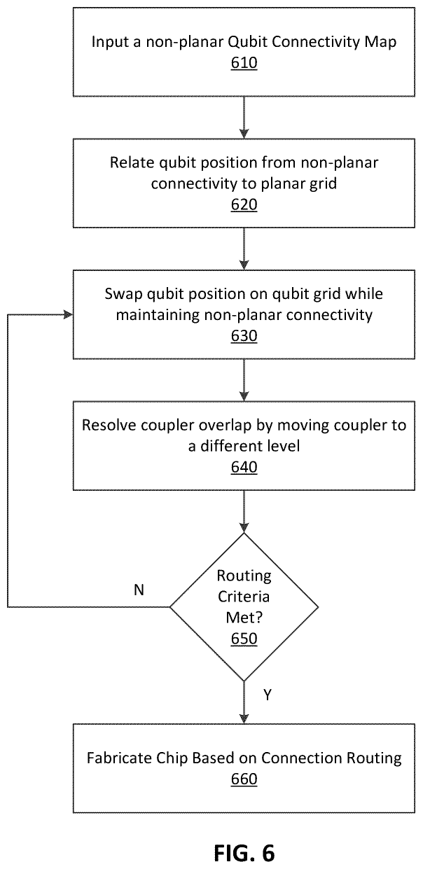

Referring to FIG. 6, an method for wiring a multilevel chip according to the architecture of the Bivariate-Bicycle Code on a planar substrate is depicted, according to an example embodiment; and

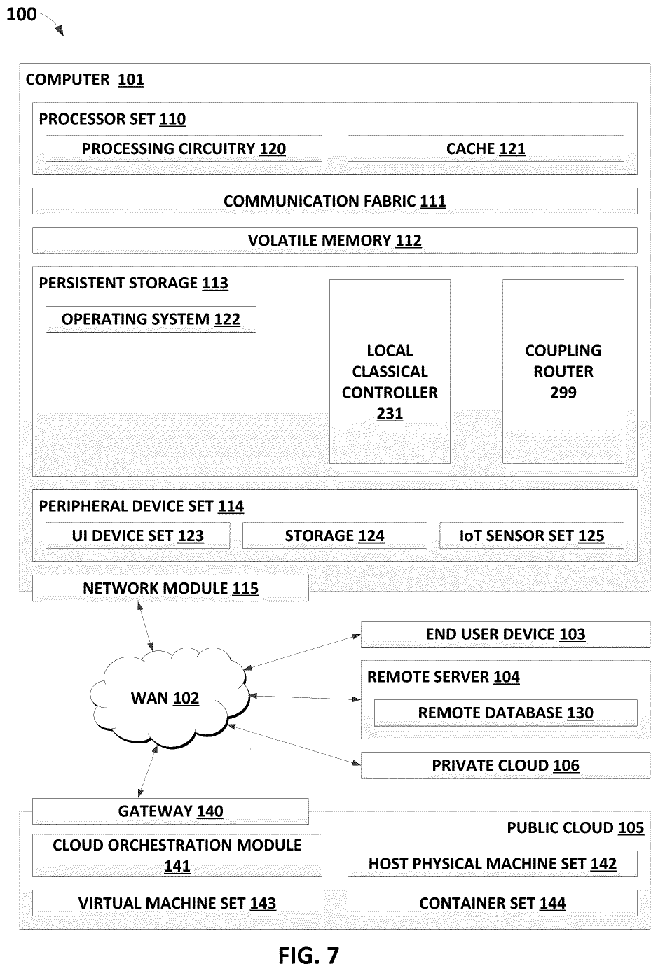

Referring to FIG. 7, a computing system is depicted, according to an example embodiment.

### DETAILED DESCRIPTION

The main obstacle to building a quantum computer is the fragility of quantum information, owing to various sources of noise affecting it. Since isolating a quantum computer from external effects and controlling it to induce a desired computation are in conflict with each other, noise appears to be inevitable. The sources of noise include imperfections in qubits, materials used, controlling apparatus, State Preparation and Measurement (SPAM) errors, and a variety of external factors ranging from local man-made, such as stray electromagnetic fields, to those inherent to the Universe, such as cosmic rays. While some sources of noise can be eliminated with better control, materials, and shielding, a number of other sources appear to be difficult, and even impossible, to remove. The latter kind can include spontaneous and stimulated emission in trapped ions, and the interaction with the bath (Purcell Effect) in superconducting circuits. Thus, error correction becomes a key requirement for building a functioning scalable quantum computer.

Quantum error correcting (QEC) codes are a way to enable the reliable use and storage of quantum information beyond the capabilities of the hardware used for quantum computations. The use and storage of quantum information in this manner can be accomplished by encoding the quantum information across multiple physical qubits, encoding with them one or several logical qubits. To create these logical qubits, entangled states are created across multiple qubits.

Low-density parity check (LDPC) codes may be one way of enabling QEC. A QEC code is of LDPC type if each check operator of the code acts only on a few qubits and each qubit participates only in a few checks. LDPC codes may include hyperbolic surface codes, hypergraph product, balanced product codes, two-block codes based on finite groups, and quantum Tanner codes. The latter were shown to be asymptotically “good” in the sense of offering a constant encoding rate and linear distance—a parameter quantifying the number of correctable errors. In contrast, the surface code has an asymptotically zero encoding rate (i.e., the ratio of logical qubits to physical qubits) and only square-root distance. Replacing the surface code with a high-rate, high-distance LDPC code could have major practical considerations. First, fault-tolerance overhead (the ratio between the number of physical and logical qubits) could be reduced dramatically. Secondly, high-distance codes exhibit a very sharp decrease in the logical error rate: as the physical error probability crosses the threshold value, the amount of error suppression achieved by the code can increase by orders of magnitude even with a small reduction of the physical error rate.

To prevent the accumulation of errors one must be able to measure the error syndrome frequently enough. This is accomplished by a syndrome measurement (SM) circuit that couples data qubits in the support of each check operator with a respective ancillary qubit by a sequence of CNOT gates. Check qubits are then measured revealing the value of the error syndrome. The time it takes to implement the SM circuit is proportional to its depth—the number of gate layers composed of non-overlapping CNOTs. Since new errors continue to occur while the SM circuit is executed, its depth should be minimized.

Referring now to FIG. 2, the above quantum error correcting code can be implemented as part of any suitable quantum system, such as quantum system 230. Quantum system 230 can be any suitable set of components capable of performing quantum operations on a physical system. In the example embodiment depicted in FIG. 2, quantum system 230 includes a local classical controller 231, a classical-quantum interface 232, and quantum processor 233. In some embodiments, all or part of each of the local classical controller 231, a classical-quantum interface 232, and quantum processor 233 may be located in a cryogenic environment to aid in the performance of the quantum operations.

Local classical controller 231 may be any combination of classical computing components capable of aiding a quantum computation, such as executing a one or more quantum operations to form a quantum circuit, by providing commands to a classical-quantum interface 232 as to the type and order of signals to provide to the quantum processor 233. Local classical controller 231 may additionally perform other low/no latency functions, such as error correction, to enable efficient quantum computations. Such digital computing devices may include processors and memory for storing and executing quantum commands using classical-quantum interface 232. Additionally, such digital computing devices may include devices having communication protocols for receiving such commands and sending results of the performed quantum computations to classical backend 220. Additionally, the digital computing devices may include communications interfaces with the classical-quantum interface 232. In an embodiment, local classical controller 231 may include all components of computer 101, or alternatively may be individual components configured for specific quantum computing functionality, such as processor set 110, communication fabric 111, volatile memory 112, persistent storage 113, and network module 115.

Classical-quantum interface 232 may be any combination of devices capable of receiving command signals from local classical controller 231 and converting those signals into a format for performing quantum operations on the quantum processor 233. Such signals may include electrical (e.g., RF, microwave, DC), optical (laser) signals, magnetic signals, or vibrational signals to perform one or more single qubit operations (e.g., Pauli gate, Hadamard gate, Phase gate), signals to preform multi-qubit operations (e.g., CNOT-gate, CZ-gate, SWAP gate), qubit state readout signals, and any other signals that might enable quantum calculations, quantum error correction, initiate the readout of a state of a qubit, and/or perform any other control function on quantum processor 233. Additionally, classical-quantum interface 232 may be capable of converting signals received from the quantum processor 233 into digital signals capable of processing and transmitting by local classical controller 231 and classical backend 220. Such signals may include qubit state readouts. Devices included in classical-quantum interface 232 may include, but are not limited to, digital-to-analog converters, analog-to-digital converters, waveform generators, attenuators, amplifiers, filters, optical fibers, and lasers.

Quantum processor 233 may be any hardware capable of using quantum states to process information. Such hardware may include a collection of qubits, mechanisms to couple/entangle the qubits (e.g., couplers), and any required signal routings to communicate between qubits or with classical-quantum interface 232 in order to process information using the quantum states. Such qubits may include, but are not limited to, charge qubits, flux qubits, phase qubits, spin qubits, and trapped ion qubits, or any other suitable qubit structures. The architecture of quantum processor 233, such as the arrangement of data qubits, error correcting qubits, and the couplings amongst them, may be a consideration in performing a quantum circuit on quantum processor 233. According to an embodiment of the invention, quantum processor may have a qubit coupling architecture based on toric coupling described above.

One type of QEC code for use in improving the performance of quantum system 200 is a Bivariate-bicycle (BB) code. For a code with a toric layout, data and check qubits can be placed on nodes of the Cayley graph of Z_2μ×Z_2λ for some integers μ,λ such that edges in the Cayley graph correspond to edges of the code's Tanner graph. The above rules may lead to the creation of a qubit coupling map, which is depicted as its tanner graph, such as the one depicted in FIG. 3C. The implementation of such codes can lead to extending the lifetime of data encoded by these codes in a quantum state using quantum processor 233, which may lead to longer circuits and enabling improved computational complexity of quantum algorithms.

For said codes possessing a toric layout, the arrangement can lead to qubits placed a half-integer points according to the following:

$$\begin{matrix}X & ( Z , Z + 1 / 2 ) \\ L & ( Z , Z ) \\ R & ( Z + 1 / 2 , Z + 1 / 2 ) \\ Z & ( Z + 1 / 2 , Z )\end{matrix}$$

By placing a first qubit from L at (0,0) and filling in the rest of the torus by following edges Aᵢ, Aⱼ, Bₚ, B_{q}, this can produce a unit cell with a layout of that in FIG. 3A, where circles denote data qubits of either L or R type, squares denote check qubits for measuring syndromes of x or z type and A and B denote the matrices of the BB code.

Referring now to FIG. 3B and FIG. 3C, a qubit coupling map, on a surface of a torus, of a BB code with parameters [[144, 12, 12]] is depicted. FIG. 3B depicts the couplings present at the boundaries of FIG. 3C. The BB code parameters may be expressed in the format [[n, k, d]], where n is the number of data qubits, k is the number of logical qubits encoded, and d is the code distance. FIG. 3C depicts an embodiment of a BB code having 144 data qubits (with 144 check qubits for a total of 288 total physical qubits), containing 12 logical qubits, with a code distance of 12. However, codes parameters of [[72, 12, 6]], [[90, 8, 10]], [[108, 8, 10]], and [[288, 12, 18]] may be implemented as well. In such an architecture, each qubit on the torus may be laid out along a grid on the surface of the torus so that each qubit is coupled with the 4 nearest qubits on the grid using in-plane couplings, while also having couplings with 2 non-nearest-neighbor qubits depicted by the example cross-couplings 310, 320, 330, and 340. In this sense, nearest neighbor refers to qubits that are within one edge from each other on surface grid of the qubit coupling map. Each of the cross-couplings may have a Manhattan distance (i.e., the number of edges on the grid required traverse between qubits) of 9. The following coupling table defines a list of example couplings that may be used for associated BB code parameters; however it is understood that other solutions may exist having different Manhattan distances. In the table, code refers to the n number of the BB code parameters, shape is the number of qubits in along both directions of the torus, and the last 4 columns represent traversing from each data qubit to its respective check qubit along the cross-coupling.

TABLE 2
Long-range edges for BB codes with a toric layout

| code | shape | L → X | R → X | L → Z | R → Z |
|---|---|---|---|---|---|
| 72 | 12 × 12 | (3, −6) | (−6, 3) | (6, −3) | (−3, 6) |
| 90 | 6 × 30 | (3, −6) | (0, −9) | (0, 9) | (−3, 6) |
| 108 | 12 × 18 | (3, −6) | (−6, 3) | (6, −3) | (−3, 6) |
| 144 | 12 × 24 | (3, −6) | (−6, 3) | (6, −3) | (−3, 6) |
| 288 | 24 × 24 | (−3, −6) | (−6, 3) | (6, −3) | (3, 6) |

While FIG. 3C only shows 4 qubits having these connections for simplicity, the pattern applies to each qubit of FIG. 3A the according to that pattern.

As used above, a cross-coupling may represent any coupling that is not to a qubit that has nearest neighbor adjacency (e.g., cannot be accomplished using a direct coupling in a two-dimensional arrangement because it must cross over a different coupling) according to physical adjacency or mapping on a surface, such as a torus. In some embodiments, a c-coupler joining superconducting qubits may be used. A c-coupler is a connection between two qubits on a chip that breaks the qubit plane, either through multi-level wiring, bump bonding, or both, to connect qubits that cannot achieve the routing on a flat surface.

Referring now to FIG. 4A, depicted is a quantum circuit for detecting an error of the qubit coupling architecture based on FIG. 3C. The error detecting circuit, which may also be referred to as a syndrome measurement circuit, first instantiates the state of the check qubit. For each data qubit of the architecture, a CNOT is applied between the data qubit and the 6 connected check qubits. Following the application of the CNOT, the state of the check qubit is measured. The ordering of CNOTs is selected based on groups of non-overlapping connections, corresponding to submatrices A1, A2, A3, B1, B2, B3, which may allow all of the CNOTs in two of such submatrices to be performed in parallel. This results in the syndrome measurement circuit having an overall depth that is independent of the dimensions of the torus, which may limit how errors propagate through the circuit and may result in improved noise resilience. Furthermore, the order of the submatrices is to be selected so that the correct syndromes are computed onto the X-check qubit and Z-qubit qubits. This ordering of the CNOTs based on sets of non-overlapping connections between qubits may achieving parallel scheduling of CNOTs resulting in a circuit depth independent of torus dimensions such that the syndrome measurement circuit will have a depth of 8. If the measurement results in a state change from the instantiated state, an error is detected and a local classical controller 231 may determine a corrective action to return the logical qubit to its previous state. This method is depicted in pseudo-code in FIG. 4B.

Applying the architecture depicted in FIG. 3C to physical layouts as described may present challenges due to the long distances required to connect left-to-right and top-to-bottom qubits. As couplings become longer, the couplings may become more “lossy” which may result in an increase in error rate beyond what may be corrected.

Referring to FIGS. 5A and 5B, a technique for reducing distance, and an example layout based on that reduction, are depicted. FIG. 5A depicts a method for reducing the surface of a torus to a plane, but this technique may be similarly applied to reducing the surface of other shapes onto a plane as well. First, the torus if flattened along a perspective such that the qubits located on a front surface and a back surface now exist on the same surface. In this example, by flattening the surface, the couplers necessary to maintain the connectivity of the torus in FIG. 3C, such as couplers that would need to extend from top-to-bottom or left-to-right, as adjacent qubits from the grid on the surface of the torus would be adjacent to each other on the grid on the planar surface. In some embodiments, flattening can include placing qubits on from the front surface on a top surface of a substrate, and qubits on a back surface onto a bottom surface of the substrate. Second, the flattened shape is folded along an axis, and the coordinates are reshaped to exist along a two-dimensional plane. The second fold along the vertical axis again eliminates the long coupling from left to right in FIG. 3C, as the qubits are adjacent to each other on the two-dimensional grid. For shapes with additional symmetries, additional folds may be necessary for each additional symmetry.

Following the flatten, fold, and reshape described above, a qubit connectivity architecture may exist having the layout depicted in FIG. 5B. In such a connectivity, R and L data qubits are not directly adjacent to two X and Z check qubits, as depicted in FIGS. 3A and 3C. Additionally, connections in this embodiment may be next-to-nearest neighbor connections (e.g., 2 Manhattan distance on a grid of a planar surface). Instead, the grid cell layout in FIG. 3A overlaps other cells when located on a planar surface, such as is depicted in how cell 510, 520, 530, and 540 overlap. Additionally, positioning of cross-couplers follows similar rules following coupling, and not grid layout out, in terms of counting for the cross-couplings to achieve the proper layout.

Referring to FIG. 6, a method for routing couplers of a connectivity graph from a non-planar surface to a planar surface is depicted using coupling router 299. Such a method may be performed using the computing system of FIG. 7. Referring to step 610, a non-planar qubit connectivity map may be input into the system, such as the toric code layout depicted in FIG. 3C. The non-planar connectivity may represent the couplings that are necessary to efficiently implement an error-correction code, such as a BB code.

Referring to step 620, the position of each qubit may be placed on a planar surface, while maintaining couplings to the qubits as originally described in the non-planar qubit connectivity map. Such couplings according to the original non-planar qubit connectivity map must be maintained throughout the routing process to ensure proper connections for the error-correcting code to operate, while enabling the optimization of coupler routing. In an example embodiment, a grid having x-y coordinates may be used.

Referring to step 630, positions of qubits on the surface may be swapped while adhering to the non-planar qubit connectivity map. Positional swaps may be performed to reduce coupling distance (total or individual), number of levels changed (e.g., TSVs and/or bump bonds used), number of coupling overlaps, or any other relevant criteria.

Referring to step 640, coupler overlaps may be resolved by placing the coupler on a different level of the structure using TSVs and/or bump bonds. The placement of the TSVs and/or bump bonds may be done to reduce unwanted interactions (e.g., crosstalk) between other couplers and qubits. In some embodiments, to reduce complexity, each level may only contain couplers traversing a single direction (only in the x direction, only in the y direction, or any other arbitrary vector). As an example use of said embodiment, for the cross couplers described in FIG. 3C, the coupler may be on a first level of the structure while traversing in an x-direction, and a second level of the structure while traversing in a y-direction.

Referring to step 650, the method may determine whether the layout created in step 640 adheres to relevant design criterion. Such a criteria may have hard design constraints (e.g., no coupler longer than a set length, no more than 4 levels of wiring), or soft constraints (e.g., reducing total coupling distance). When design constraints have been met, the method proceeds to step 660. When the design constraints have not been met, the method returns to step 630 for further optimization.

Referring to optional step 660, a quantum processing unit may be fabricated according to the layout. Such fabrication may be achieved using any combination of suitable techniques such as, for example, deposition, lithography, etching, doping, or any other common fabrication techniques.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as local classical controller 231 or coupling router 299. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private cloud 106 and public cloud 105 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A structure comprising:
a plurality of qubits;
a plurality of couplings between each qubits, wherein the couplings are arranged based on a relationship between each qubit and its placement on a torus, and wherein a coupling for each qubit comprises coupling to four nearest neighbor qubits on the torus and coupling to two cross-coupled qubits based on a definition and a set of parameters of a bivariate bicycle code.

2. The structure of claim 1, wherein a unit cell located on a grid of the torus comprises a first data qubit, an X-check qubit, a second data qubit, and a Z-check qubit, wherein the unit cells are arranged such that four nearest neighbor qubits of either the first data qubit or second data qubit are two X-check qubits and two Z-check qubits.

3. The structure of claim 2, wherein a Manhattan distance of the coupling for the two cross-coupled qubits is 9.

4. The structure of claim 1, wherein the parameters of the bivariate bicycle code are [[144, 12, 12]].

5. The structure of claim 1, wherein a routing for the two cross-couplings are based on a coupling table for the parameters of the bivariate bicycle code.

6. A method of performing an error check on a quantum architecture, wherein the quantum architecture comprises:
a plurality of qubits;
a plurality of couplings between each qubits, wherein the couplings are arranged based on a relationship between each qubit and its placement on a torus, and wherein a coupling for each qubit comprises coupling to four nearest neighbor qubits on the torus and coupling to two additional qubits based on a definition and a set of parameters of a bivariate bicycle code;
and wherein the error check comprises:
initializing a plurality of X-check qubits and Z-check qubits coupled to a first data qubit and a second data qubit;
performing a CNOT gate using each coupling of a first data qubit, and each coupling of a second data qubit;
measuring each coupled X-check qubit used in each CNOT gate; and
measuring each coupled Z-check qubit used in each CNOT gate; and
determining an error based on switched state of any of the X-check qubits or Z-check qubits.

7. The method of claim 6, wherein a unit cell located on a grid of the torus comprises a first data qubit, an X-check qubit, a second data qubit, and a Z-check qubit, wherein the unit cells are arranged such that four nearest neighbor qubits of either the first data qubit or second data qubit are two X-check qubits and two Z-check qubits.

8. The method of claim 7, wherein a Manhattan distance of the coupling for the two additional qubits is 9.

9. The method of claim 7, a routing for the two cross-couplings are based on a coupling table for the parameters of the bivariate bicycle code.

10. The method of claim 6, wherein an ordering of the CNOTs is based on sets of non-overlapping connections between qubits, achieving parallel scheduling of CNOTs resulting in a circuit depth independent of torus dimensions.

11. A method of routing couplings of qubits comprising:
receiving a qubit connectivity map on a non-planar surface comprising a plurality of qubits and a plurality of couplings between qubits;
relating qubit position from the non-planar surface map to a planar surface;
swapping positions of qubits on the planar surface while maintaining the couplings from the qubit connectivity map;
determining a device layout by placing qubits according to locations on the planar surface and couplers between the qubits corresponding to the coupling map;
changing a wiring level of a coupler in the device layout based on a physical overlap with another coupler.

12. The method of claim 11, wherein relating a position of the qubit from the non-planar surface comprises flattening the non-planar surface to a planar surface s.

13. The method of claim 12, wherein flattening comprises overlapping a grid on a front surface of the non-planar surface with a grid from a back surface of the non-planar surface such that the grids coexist on a same surface of the planar surface.

14. The method of claim 12, wherein flattening comprises placing a grid from a back surface of the non-planar surface a bottom surface of a planar substrate and a grid from a front surface of the non-planar qubit connectivity map on a top surface of the planar substrate.

15. The method of claim 12 further comprising folding the planar surface along an axis.

16. The method of claim 11, wherein couplers on each wiring level only traverse a single direction.

17. The method of claim 16, wherein a first wiring level traverses an x-direction of the grid of the planar substrate.

18. The method of claim 17, wherein a second wiring level traverses a y-direction of the grid of the planar substrate.

19. The method of claim 11 further comprising causing fabrication of a device based on the device layout.

20. A structure comprising:
a qubit connectivity graph comprising a plurality of repeating unit cells of qubits and couplings;
a first unit cell comprising coupled qubits located on a surface of a planar substrate; and
a second unit cell comprising coupled qubits located on the surface of the planar substrate, wherein qubits of the first unit cell are located between qubits of the second unit cell.

21. The structure of claim 20, wherein the repeating unit cells comprise a first data qubit, an X-check qubit, a second data qubit, and a Z-check qubit, wherein the unit cells are arranged such that four nearest neighbor qubits of either the first data qubit or second data qubit are two X-check qubits and two Z-check qubits.

22. The structure of claim 20, wherein couplings of the first unit cell and the second unit cell are based on a qubit connectivity map created a non-planar surface.

23. The structure of claim 22, wherein the non-planar surface is a torus.

24. The structure of claim 20, wherein the unit cells are overlapping.

25. The structure of claim 20, wherein coupling between an x-check qubit and L-data qubit is routed past a qubit of the second unit cell.
